(19) United States
(12) Patent Application Publication
(10) Pub. No.: US 2009/0222310 A1
(43) Pub. Date: Sep. 3, 2009

(54) TECHNIQUES TO ALLOCATE PROJECT RESOURCES

(75) Inventors: Thomas Vollmer, Bellevue, WA (US); Radu Serbanescu, Bellevue, WA (US); Alin Flaidar, Kirkland, WA (US); Marius Bunescu, Bellevue, WA (US); Ryan Psenski, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/039,808

(22) Filed: Feb. 29, 2008

(51) Int. Cl. G06Q 10/00

(52) U.S. Cl. 705/8; 705/1

(57) ABSTRACT

Techniques to allocate project resources are described. An apparatus comprises an enhanced PPM component operative to manage a model project investment portfolio of multiple projects for an organization. The enhanced PPM component may include a portfolio definition module operative to receive one or more portfolio parameters controlling resource allocations for multiple candidate projects, a resource allocation module communicatively coupled to the portfolio definition module, the resource allocation module operative to allocate resources to the multiple candidate projects based on the portfolio parameter to form resourced candidate projects and unresourced candidate projects, and a portfolio planning module communicatively coupled to the resource allocation module, the portfolio planning module operative to generate a graphical user interface planning view having resourced candidate projects, unresourced candidate projects, and time-phased information for each candidate project. Other embodiments are described and claimed.

### BACKGROUND

Enterprise project management (EPM) is a field of organizational development that attempts to manage and govern multiple projects for an organization from a unified perspective. Organizations typically use an EPM system to implement a set of uniform EPM techniques designed to manage, monitor and assess the status of all projects in the organization. Some EPM systems implement various project portfolio management (PPM) techniques to create and manage a project investment portfolio of existing and future projects for an organization. PPM refers to the activity of selecting which projects to keep in a project portfolio because of their anticipated business value, and which ones to discard.

PPM techniques typically include the ability to create various scenarios to decide an optimal portfolio of projects for a given set of constraints, such as a time constraint, fiscal constraint, or other resource constraint. For example, a business entity typically has multiple candidate business projects, each of which has a corresponding set of resource requirements and a corresponding business value that is based on a risk and an expected return. PPM techniques are used to generate a set of proposed business projects that maximizes a total value while remaining within a set of given constraints.

Conventional PPM techniques, however, are typically static in nature and do not provide robust and configurable solutions based on different planning considerations. Consequently, business decisions regarding particular business projects to implement are not made with a complete understanding as to relative risk and/or a total value that will be provided to a business entity. Accordingly, improvements with respect to these considerations and others may be needed.

### SUMMARY

Various embodiments are generally directed to EPM systems. Some embodiments are particularly directed to EPM systems having an enhanced PPM component to manage a model project investment portfolio having multiple candidate projects for an organization. In one embodiment, for example, an EPM system may include an enhanced PPM component implementing, among other features, an improved resource allocation technique designed to identify and resolve resource deficits among the multiple candidate projects in the model project investment portfolio.

In one embodiment, for example, an apparatus may have an enhanced PPM component operative to manage a model project investment portfolio of multiple projects for an organization. The enhanced PPM component may include a portfolio definition module operative to receive one or more portfolio parameters controlling resource allocations for multiple candidate projects. The enhanced PPM component may also include a resource allocation module communicatively coupled to the portfolio definition module, the resource allocation module operative to allocate resources to the multiple candidate projects based on the portfolio parameter to form resourced candidate projects and unresourced candidate projects. The enhanced PPM component may further include a portfolio planning module communicatively coupled to the resource allocation module, the portfolio planning module operative to generate a graphical user interface (GUI) planning view having resourced candidate projects, unresourced candidate projects, and time-phased information for each candidate project. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates one embodiment of an enhanced PPM component.

FIG. 2 illustrates one embodiment of a first GUI view.

FIG. 3 illustrates one embodiment of a second GUI view.

FIG. 4 illustrates one embodiment of a logic flow.

FIG. 5 illustrates one embodiment of a computing system architecture.

FIG. 6 illustrates one embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments are generally directed to EPM systems. An EPM system may implement a set of uniform EPM techniques designed to manage, monitor and assess the status of all projects in the organization. The EPM system may comprise various elements designed for a singular computing architecture comprising a single device, such as a desktop environment. Alternatively or additionally, the EPM system may comprise various elements designed for a distributed computing architecture comprising multiple devices, such as a network or web-based environment. Examples of an EPM system may include without limitation an EPM suite including one or more EPM application programs such as MICROSOFT® PROJECT, MICROSOFT OFFICE PROJECT SERVER, and MICROSOFT OFFICE PROJECT PORTFOLIO SERVER, all made by Microsoft Corporation, Redmond, Wash. The embodiments, however, are not limited to these examples.

An EPM system generally creates budgets based on assignment work and resource rates. As resources are assigned to tasks and assignment work estimated, the program calculates the cost equals the work times the rate, which rolls up to the task level and then to any summary tasks and finally to the project level. Resource definitions (e.g., people, equipment and materials) can be shared between projects using a shared resource pool. Each resource can have its own calendar, which defines what days and shifts a resource is available. Resource rates are used to calculate resource assignment costs which are rolled up and summarized at the resource level. Each resource can be assigned to multiple tasks in multiple plans and each task can be assigned multiple resources, and the application schedules task work based on the resource availability as defined in the resource calendars. All resources can be defined in an enterprise-wide resource pool.

Some embodiments are particularly directed to EPM systems having an enhanced PPM component to generate and manage a model project investment portfolio having multiple projects for an organization. The enhanced PPM component may implement various enhanced PPM techniques to create and manage a project investment portfolio of existing and future projects for an organization, such as a business entity. In particular, the enhanced PPM component may assist an operator such as a project planner in selecting which candidate projects to keep or discard in a model project investment portfolio based on their anticipated business value. The enhanced PPM component provides the ability to model various scenarios to decide an optimal portfolio of projects for a given set of constraints, such as a time constraint, fiscal constraint, or other resource constraint. The enhanced PPM component generates a set of proposed or candidate business projects that maximize a total strategic value while remaining within a set of given constraints for each candidate project.

The enhanced PPM component may further utilize one or more portfolio parameters to vary a characteristic or assumption at a portfolio level in order to model changes across an entire set of candidate projects for a model project investment portfolio. In one embodiment, for example, a portfolio parameter comprising a portfolio resource constraint parameter representing financial resources may be modified, and resources allocated to the individual candidate projects may be modified accordingly based on the portfolio resource constraint parameter. Other portfolio parameters may be modified as well to model changes to the model project investment portfolio, such as portfolio parameters designed to change the start date of individual projects in an effort to resolve resource deficits, force-in or force-out certain projects in order to resolve resource deficits, simulate hiring of additional personnel to resolve resource deficits, and so forth. In this manner, an operator may quantify and model changes to the model project investment portfolio at both an individual project level and a portfolio level. Consequently, the enhanced PPM component provides a more robust planning tool to refine a model project investment portfolio to better understand the complexities and inter-relationships between various combinations of resourced and unresourced candidate projects. Accordingly, business decisions regarding particular business projects to implement can be made with a better understanding as to relative risk and/or a total value that will be provided to a business entity.

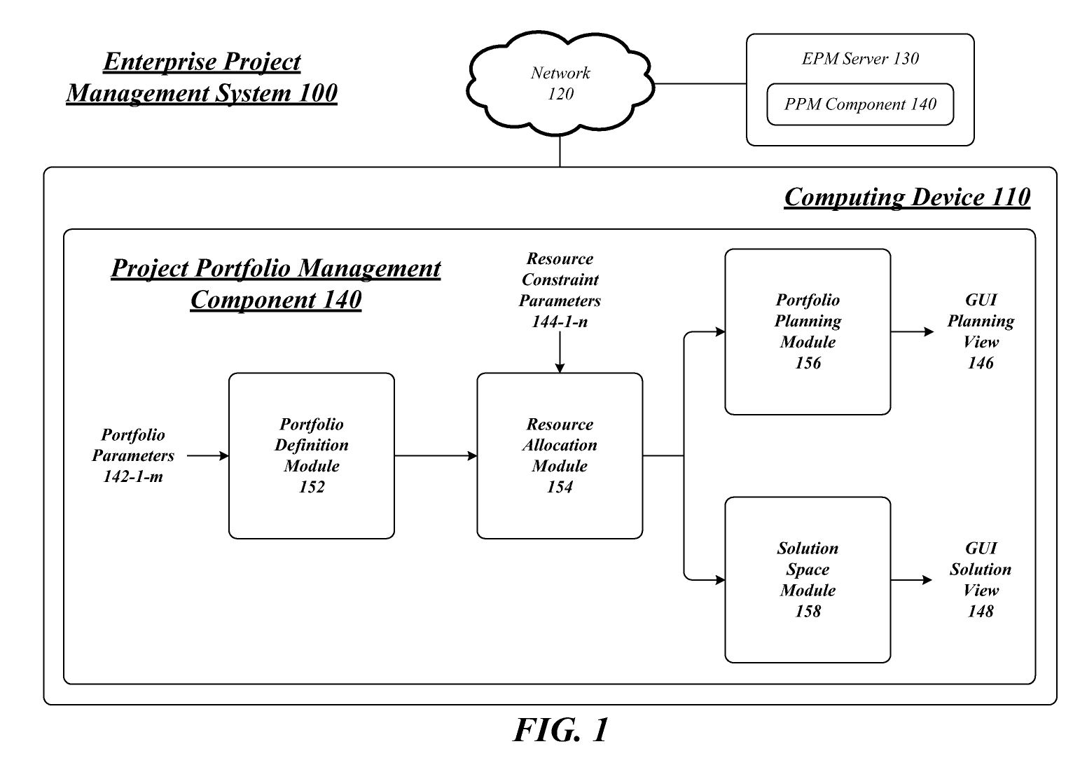

FIG. 1 illustrates a block diagram for an EPM system 100. The EPM system 100 may represent a general system architecture suitable for implementing various EPM techniques designed to manage, monitor and assess the status of all projects in an organization, such as an enterprise or business entity. Examples for the EPM system 100 may include without limitation one or more electronic devices implementing one or more EPM application programs from an EPM suite, including MICROSOFT® PROJECT, MICROSOFT OFFICE PROJECT SERVER, and MICROSOFT OFFICE PROJECT PORTFOLIO SERVER, all made by Microsoft Corporation, Redmond, Wash. The embodiments, however, are not limited to these examples.

The EPM system 100 may comprise various elements designed for a singular computing architecture comprising a single electronic device, such as a desktop environment. Alternatively or additionally, the EPM system may comprise various elements designed for a distributed computing architecture comprising multiple electronic devices, such as a network or web-based environment. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although the EPM system 100 as shown in FIG. 1 has a limited number of elements in a certain topology, it may be appreciated that the EPM system 100 may include more or less elements in alternate topologies as desired for a given implementation. The embodiments are not limited in this context.

As used herein the terms “component” and “system” are intended to refer to a computer-related entity, either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In various embodiments, the EPM system 100 may comprise, or form part of, a wired communications system, a wireless communications system, or a combination of both. For example, the EPM system 100 may include one or more elements arranged to communicate information over one or more types of wired communications links. Examples of a wired communications link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The EPM system 100 also may include one or more elements arranged to communicate information over one or more types of wireless communications links. Examples of a wireless communications link may include, without limitation, a radio channel, infrared channel, radio-frequency (RF) channel, Wireless Fidelity (WiFi) channel, a portion of the RF spectrum, and/or one or more licensed or license-free frequency bands.

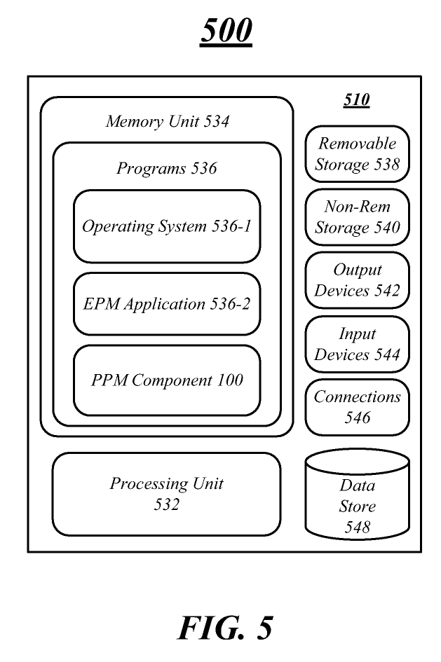

In the illustrated embodiment shown in FIG. 1, a computing device 110 may connect to an EPM server 130 over one or more communications connections via a network 120. The EPM server 130 may comprise any logical or physical entity that is arranged to interoperate with the computing device 110 to perform project management operations. The EPM server 130 and the computing device 110 may communicate project information over a network 120. Network 120 may comprise, for example, a packet-switched network, a circuit-switched network, or a combination of both. In various embodiments, the EPM server 130 may comprise or be implemented as any processing or computing device, such as a computer, a server, a server array or server farm, a work station, a mini-computer, a main frame computer, a supercomputer, and so forth. The EPM server 130 may comprise or implement a general or specific computing architecture suitable for communicating and processing multimedia information. In some implementations, the EPM server 130 may be implemented using a general or specific computing architecture similar to the computing architecture described with reference to FIG. 5. Examples for the EPM server 130 may include without limitation a MICROSOFT OFFICE PROJECT SERVER, a MICROSOFT OFFICE PROJECT PORTFOLIO SERVER, and so forth.

In various embodiments, the EPM system 100 may include one or more computing devices 110. The computing device 110 may be implemented as any device that includes, in its most basic form, a processing system including a processor and memory, one or more multimedia input/output (I/O) components, and a wireless and/or wired network connection. Examples of multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of the computing device 110 may include a mobile device, a personal digital assistant (PDA), a combination cellular telephone and PDA, a mobile computing device, a smart phone, a cellular telephone, a one-way pager, a two-way pager, a messaging device, a computer, a personal computer (PC), a desktop computer, a laptop computer, a notebook computer, a handheld computer, a server, a work station, a mini-computer, a main-frame computer, a network appliance, a web appliance, and so forth. In some implementations, the computing device 110 may be implemented using a general or specific computing architecture similar to the computing architecture described with reference to FIG. 5.

The EPM server 130 and/or the computing device 110 may include, among other elements, an enhanced PPM component 140. The enhanced PPM component 140 may comprise part of another application program, such as MICROSOFT PROJECT, MICROSOFT OFFICE PROJECT SERVER, and MICROSOFT OFFICE PROJECT PORTFOLIO SERVER. The enhanced PPM component 140 may also comprise a standalone application program accessible to other application programs via a set of application program interfaces (APIs) or other interface.

The enhanced PPM component 140 may generally be arranged to manage a model project investment portfolio of multiple candidate projects for an organization. An organization such as a business entity typically has a number of candidate projects that it would like to complete given a set of resource constraints, such as time constraints, fiscal constraints, material constraints, equipment constraints, labor constraints, and so forth. The enhanced PPM component 140 provides the EPM system 100 with the ability to model various scenarios to decide an optimal portfolio of candidate projects for a given set of constraints. The enhanced PPM component 140 generates a set of proposed or candidate business projects that maximize a total strategic value, while remaining within a set of given constraints for each candidate project. The total strategic value is typically represented as a total amount of revenue derived from a given set of candidate projects, although other metrics may be used as well. For example, a total strategic value could be based on potential impact to a set of defined “business drivers.” Each project could get rated against a business driver, and together with corresponding business driver priorities, the enhanced PPM component 140 can generate a strategic value per project.

As shown in the illustrated embodiment of FIG. 1, the enhanced PPM component 140 may include a portfolio definition module 152 operative to receive one or more portfolio parameters 142-1-m controlling resource allocations for multiple candidate projects. In various embodiments, the enhanced PPM component 140 may utilize one or more portfolio parameters 142-1-m to vary a characteristic or assumption at a portfolio level in order to model changes across an entire set of candidate projects for a model project investment portfolio. In one embodiment, for example, a portfolio parameter 142-1 comprising a portfolio resource constraint parameter representing financial resources may be modified, and resources allocated to the individual candidate projects may be modified accordingly based on the portfolio resource constraint parameter. Other portfolio parameters 142-1-m may be modified as well to model changes to the model project investment portfolio, such as portfolio parameters designed to change the start date of individual projects in an effort to resolve resource deficits, force-in or force-out certain projects in order to resolve resource deficits, simulate hiring of additional personnel to resolve resource deficits, and so forth. Some examples of portfolio parameters 142-1-m may include without limitation a portfolio resource constraint parameter, a portfolio resource unit parameter, a portfolio resource type parameter, a portfolio resource rate parameter, a project scheduling dependency parameter, a resource allocation threshold parameter, a force status parameter, and others. The embodiments are not limited in this context.

The enhanced PPM component 140 may also include a resource allocation module 154 communicatively coupled to the portfolio definition module 152. The resource allocation module 154 may be arranged to allocate various resources to the multiple candidate projects on a project level. For example, the resource allocation module 154 may receive various resource constraint parameters 144-1-n corresponding to the multiple candidate projects. The resource allocation module 154 may place all the collective resources available to the organization in a resource pool, and begin allocating resources to the various multiple candidate projects based on the various resource constraint parameters 144-1-n provided for each candidate project.

During resource allocation, the resource allocation module 154 may have resource conflicts or deficits that make it difficult, and in some cases impossible, to allocate sufficient resources needed for each candidate project. The resource allocation module 154 may therefore output a model project investment portfolio having resourced candidate projects and unresourced candidate projects based on the resource constraint parameters 144-1-n and available resources within the resource pool.

An example scenario may highlight some of the limitations of using only the resource constraint parameters 144-1-n to allocate resources to the candidate projects. Assume a Company A has a list of 5 projects it could potentially work on during fiscal year 2008. The cost and the value of each project are known. Using the PPM component 140, the Company A can decide which of the 10 projects to work on given the constraints. In other words, the PPM component 140 helps answer this question: “which set of projects provides the most value given a specific cost constraint (e.g. $100,000)?” The result of using the PPM component 140 could be that projects 1, 3 and 4 provide the most value for a maximum cost of $100,000. Further, the PPM component 140 supports multiple simultaneous constraints. In addition to project cost, a popular second constraint is total number of resources, e.g., how many workers are needed to work on each project. However, this constraint is an aggregate number across the entire project duration (e.g. Jan. 1, 2007 to Aug. 31, 2007) and across all resource roles (e.g., developer, tester, product manager). This can lead to a situation where the PPM component 140 selects a set of projects that is not feasible if time-phased and role-phased resource requirements are taken into account. For example, the Company A might have a total of 10 resources (2 of which are developers), and the 5 projects need a total of 9 resources. This seems feasible until time-phased and role-phased resource requirements are taken into account, which reveal that only 2 of the 10 available workers are developers and two of the five projects need both of them at the same time.

To change the model project investment portfolio, an operator may change one or more of the resource constraint parameters 144-1-n for one or more of the candidate projects. Changes to the resource constraint parameters 144-1-n for a single candidate project, however, may not substantially impact other candidate projects, particularly if they do not utilize the same resources. Making such changes on a project level may therefore involve changing a relatively large number of resource constraint parameters 144-1-n on a project-by-project basis to achieve the desired level of strategic value for the entire model project investment portfolio. This process can be tedious and time-consuming for the operator. Furthermore, changes to the resource constraint parameters 144-1-n on a project level may not provide an optimal set of resourced projects relative to the entire model project investment portfolio.

To solve these and other problems, the resource allocation module 154 may be operative to allocate various resources to the multiple candidate projects based on the portfolio parameter 142-1-m to form a new set of resourced candidate projects and unresourced candidate projects. For example, once the resource allocation module 154 generates a model project investment portfolio using the resource constraint parameters 144-1-n, an operator may model changes to the entire model project investment portfolio using the portfolio parameters 142-1-m. The resource allocation module 154 may re-allocate resources from the resource pool based on the resource constraint parameters 144-1-n, and any additional resources provided by the portfolio parameters 142-1-m. In this manner, a set of portfolio level criteria may be used to model changes across the entire model project investment portfolio, thereby enhancing the ability of a project planner to make relevant business decisions regarding particular business projects to implement with a better understanding as to relative risk and/or a total value that will be provided to a business entity.

The resource allocation module 154 may implement various resource allocation algorithms capable of allocating various project resources based on the resource constraint parameters 144-1-n, and allocating (or re-allocating) project resources based on the portfolio parameters 142-1-m. An exemplary resource allocation algorithm suitable for use by the resource allocation module 154 is described in the form of pseudo-code as follows:

```
Sort projects by dependencies, force status and priorities (descending)
Repeat (*)
    For each project
        If depends on an Out processed project or
        Is excluded by an In processed project
            Then exclude project
                If forced in then signal infeasibility
        If forced out
            If any processed In project depends on this
                If Forced in then signal infeasibility
                else take dependent project Out and start again (*)
            break - there are only forced out projects left
        Try allocate resources for project
        If allocation failed
          If forced-in then signal infeasibility
          If any processed In project depends on this
            take dependent project Out and start again (*)
Level hired roles
Allocate resources for project
Check phase, no changes in the resource pool:
For each time frame in project life
    For each requested role
        If resources are not available
            If internal hiring
                Round up the required FTE
            If dollars budget and internal hiring
                then compute hiring cost to the end of planning
            horizon
                else compute hiring for current time frame
            If budget (dollars or FTE) exhausted
                Fail allocation and bail out
            If internal hiring
                Roll internal role hires for the remaining time
frames
        else allocate requested resources
Commit phase, take from or add through hiring to resource pool:
For each time frame in project life
    For each requested role
        If budget accommodates request
            allocate resource from the common pool
        else if internal hiring
            Commit internal role hires for the remaining time frames in
the
            Planning horizon
        Else if external hiring
            Commit hiring for this time frame
Level hired roles
If internal hiring
    Sort by project, role and time frame
    While unprocessed hiring left
        For each contiguous same project-role sequence in time frames
            While hiring left in sequence
                Look for minimum hiring in the sequence
                Look for its duration in the sequence
                Store new hiring with found value, current time
                frame as starting point
                    and calculated duration
            Substract new hiring from the sequence
```

As indicated by the above-referenced pseudo-code, the resource allocation module 154 implements a resource allocation algorithm designed to sort projects by dependencies, force status and priorities, determine changes in a resource pool, and allocate resources to candidate projects from the resource pool.

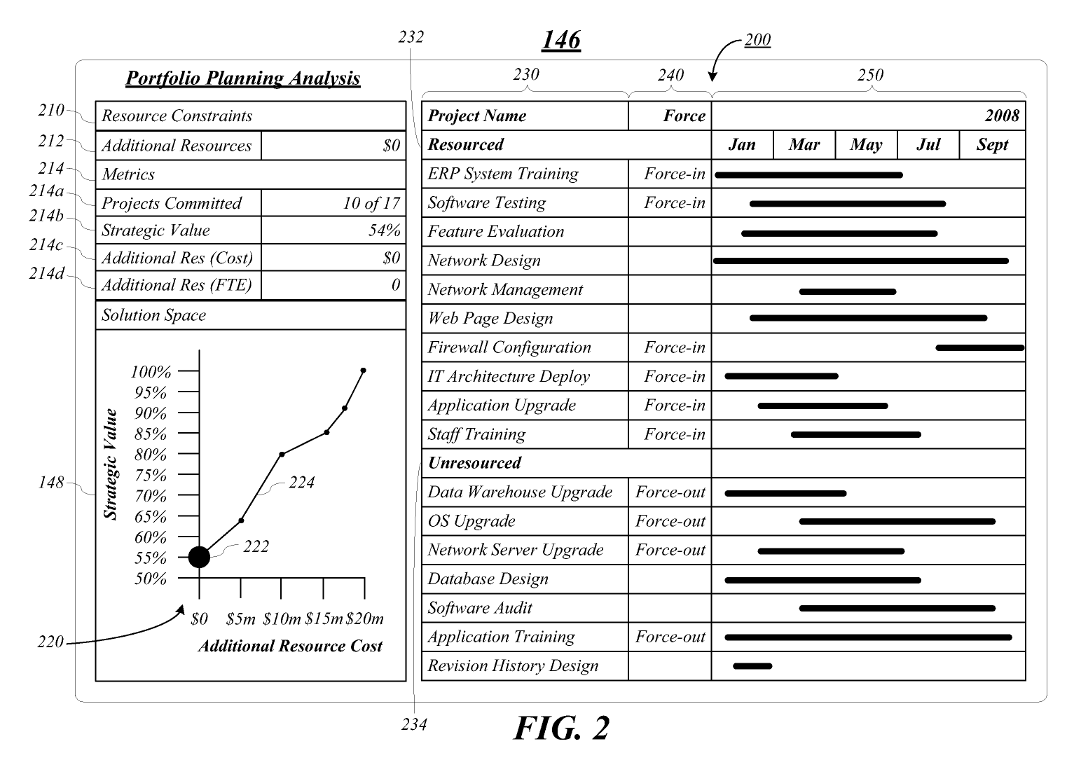

The enhanced PPM component 140 may further include a portfolio planning module 156 communicatively coupled to the resource allocation module 154. The portfolio planning module 156 may be operative to generate a GUI planning view 146 having resourced candidate projects, unresourced candidate projects, and time-phased information for each candidate project. The GUI planning view 146 may provide an operator with a multimedia GUI designed to demonstrate resource deficits and surpluses on a project basis, role basis, or time basis. An example of the GUI planning view 146 may be described in more detail with reference to FIG. 2.

The enhanced PPM component 140 may also include a solution space module 158 communicatively coupled to the resource allocation module 154 and/or the portfolio planning module 156. The solution space module 158 may be arranged to generate a GUI solution view 148 having a solution space chart with an x-axis representing portfolio resource constraint parameters and a y-axis representing strategic portfolio values. The GUI solution view 148 may provide a visual representation of how changes to the portfolio parameters 142-1-m affect the overall strategic value achieved by the model project investment portfolio.

The solution space module 158 may implement various solution space algorithms capable of visualizing the impact of various portfolio parameters 142-1-n on the model project investment portfolio. An exemplary solution space algorithm suitable for use by the solution space module 158 is described in the form of pseudo-code as follows:

Calculate N data points (Xn, Yn | 1 <= n <= N, N = 16):

| 1. | Calculate data point 1 | |
|---|---|---|
| | a. | X1 = $0 |
| | b. | Y1 = Run allocation algorithm and calculate sum of value of |
| | | all resourced projects (constraint = $0) |
| 2. | Calculate data point N | |
| | a. | XN = Run allocation algorithm and calculate total cost of |
| | | additionally required resources for all projects (no |
| | | constraint) |
| | b. | YN = 100% |
| 3. | Calculate remaining data points (2 <= n <= N−1) | |
| | a. | Xn = (n−1) * (XN/(N−1)) |
| | b. | Yn = Run allocation algorithm and calculate sum of value of |
| | | all resourced projects (constraint = $Xn) |

An example of the GUI solution view 148 may be described in more detail with reference to FIG. 2.

FIG. 2 illustrates examples for the GUI views 146, 148. The GUI views 146, 148 may provide examples for GUI views suitable for use to visualize a given model project investment portfolio information. Each of the GUI views 146, 148 may comprise various user interface elements for displaying options and/or information to an operator. It may be appreciated that the GUI views 146, 148 are merely examples of the type of GUI views that may be used to surface model project investment portfolio information, and provide various options to model changes to the module project investment portfolio for a given planning session.

In the illustrated embodiment shown in FIG. 2, the GUI planning view 146 includes various GUI elements, including a model project investment portfolio 200. The model project investment portfolio 200 may comprise a matrix including columns 230, 240, 250 with varying types of project information.

The column 230 may include project names, categorized into resource projects 232 and unresourced projects 234. The resourced projects 232 may represent those candidate projects that have been allocated a sufficient amount of project resources needed to realize completion of the candidate projects. The unresourced projects 234 may represent those candidate projects that have not been resourced sufficiently to realize completion. In some cases, the unresourced projects 234 may be partially resourced but may be missing certain resources needed to complete the candidate projects.

The column 240 may include a field for a force status parameter for each of the projects 232, 234. The force status parameter may comprise a configurable parameter that allows an operator to force the resource allocation module 154 to resource certain projects, and not resource other projects. For example, when the force status parameter is set to a “force-in” value (e.g., set to TRUE) for a candidate project, the resource allocation module 154 automatically resources the candidate project. Similarly, when the force status parameter is set to a “force-out” value (e.g., set to FALSE) for a candidate project, the resource allocation module 154 automatically excludes the candidate project from consuming any resources from the resource pool. This allows the operator the ability to prioritize those candidate projects according to their relative value to the business entity. Furthermore, the force status parameter allows the operator to override or partially control the resource allocation algorithm. This may be desirable when there is some additional information that is unknown by the EPM system 100 but that potentially influences project priority. Additional or alternatively, the force status parameter may comprise weighted priority values (e.g., 1, 2, 3, 4, and so forth) that allow sorting and ordering of the candidate projects based on operator-configurable values, thereby providing varying levels of granularity as desired for a given implementation.

The column 250 may include time-phased information for each of the projects 232, 234, including a projected start date and a projected end date for each of the projects 232, 234. For example, the column 250 may have a varying number of sub-columns, each representing a time interval of varying durations (e.g., days, months, years, and so forth). For each of the projects 232, 234, the column 250 may include a GUI element such as a line indicating a start date, intermediate dates, and an end date. In this manner, the time-phased information provides a relative quick time comparison between the projects 232, 234, which may be particularly useful when determining whether to modify time constraints for the individual projects 232, 234, and/or a portfolio parameter 142-1-m representing a modified time constraint for the entire model project investment portfolio 200.

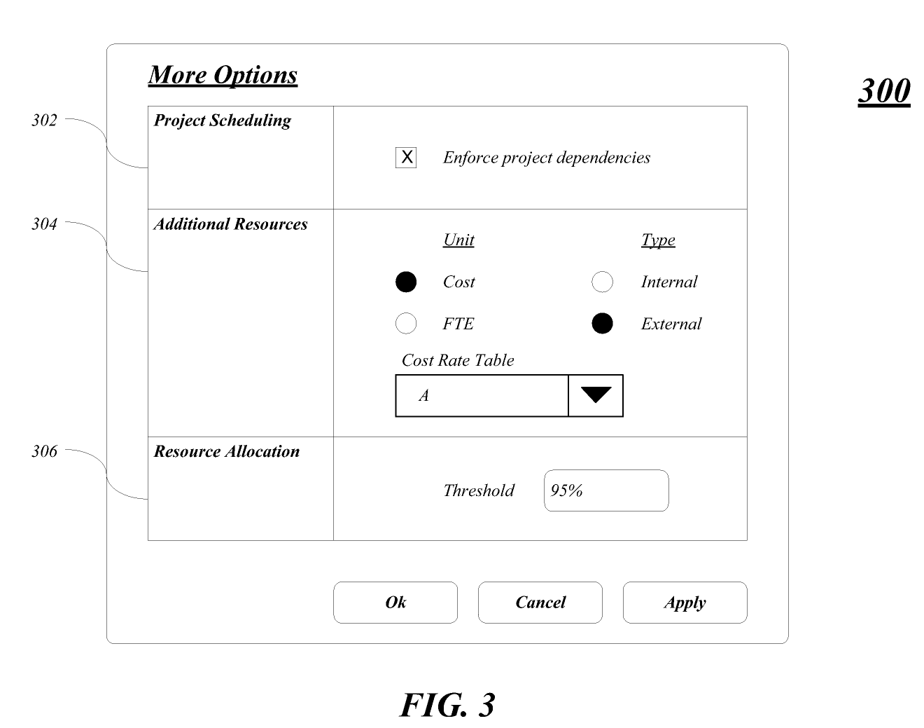

The GUI planning view 146 also includes a section for entering or selecting various portfolio parameters 142-1-m. In the illustrated embodiment shown in FIG. 2, the GUI planning view 146 includes a resource constraints area 210 having an additional resources field 212 for entering a portfolio parameter 142-1 in the form of additional resources defined in financial amounts (e.g., dollar amounts) or full-time equivalent (FTE) units, depending on the “Unit” setting as shown in FIG. 3. The additional resources field 212 may be modified for different types of portfolio parameters 142-1-m as described with reference to FIG. 3.

In one embodiment, the portfolio definition module 152 may be arranged to receive a portfolio parameter 142-1-m comprising a portfolio resource constraint parameter 142-1. The portfolio resource constraint parameter 142-1 may represent financial resources. The type of financial resources may comprise different units, including a currency unit (e.g., dollars) or a FTE unit. The resource allocation module 154 may receive the portfolio resource constraint parameter 142-1 from an operator via the portfolio definition module 152, and allocate additional resources to the multiple candidate projects 232, 234 based on the portfolio resource constraint parameter 142-1. For example, assume an operator defines the portfolio resource constraint parameter 142-1 as a currency amount of $10,000,000. The resource allocation module 154 may receive the $10,000,000, add it to the resource pool, and re-allocate resources to the candidate projects 232, 234 according to the resource allocation algorithm. Adding the additional resources of $10,000,000 will likely increase the number of resourced candidate projects 232, and decrease the number of unresourced candidate projects 234, thereby increasing the overall strategic value of the model project investment portfolio 200 (as indicated by the solution space chart 220 described below). It may be appreciated that the rate of increase/decrease of the candidate projects 232, 234 may not necessarily be linear with respect to the portfolio resource constraint parameters 142-1 due to the many variables associated with the various candidate projects 232, 234, including but not limited to the resource constraint parameters 144-1-n. Consequently, the use of a portfolio parameter 142-1-m may allow a project planner to converge to a desired solution at a faster rate than manipulating the resource constraint parameters 144-1-n.

The GUI planning view 146 also includes a section for displaying various types of metric information 214 associated with the model project investment portfolio 200. In the illustrated embodiment shown in FIG. 2, the metrics 214 include a projects committed field 214a illustrating the metric information “10 of 17” indicating explicitly that there are “10” resourced projects 232 out of a total of “17” candidate projects, and implicitly that there is 7 unresourced projects 234. The metrics 214 also includes a strategic value field 214b illustrating the metric information “54%” indicating that the current strategic value for the model project investment portfolio 200 is 54% out of a possible 100% value. An operator may model the impact of additional resources 212, in part, by viewing increases and decreases to the strategic value field 214b. The metrics 214 may further include an additional resource cost field 214c and an additional resource FTE field 214d. The additional resource fields 214c, 214d may display the additional resources needed and/or currently modeled for a given level of strategic value.

The GUI planning view 146 may further include the GUI solution view 148. The GUI solution view 148 illustrates a solution space chart 220. The solution space module 158 may automatically generate the solution space chart 220 by calculating several solutions when the portfolio planning analysis is first created. The solution space chart 220 represents a map the operator or user can use to get a sense of the solution space and its boundaries. As the operator makes changes, the operator can refer back to the solution space chart 220 to visualize how the new solution compares to the old solution, and whether the operator is making progress towards a given level of strategic value. The x-axis of the solution space chart 220 represents additional (hired) resources in terms of cost or FTE. The y-axis represents a strategic portfolio value, which is a sum of priorities of resourced projects 232. The highest y-axis value will typically be the highest reachable strategic value, which is normally less than 100%. This is because the PPM component 140 will normally not select all candidate projects, and therefore the priorities do not necessarily need to be re-normalized.

In the illustrated embodiment shown in FIG. 2, the solution space chart 220 includes a marker 222 and a line 224. The line 224 may represent one or more solutions (including a baseline solution) each with increasing additional resource constraints as generated by the resource allocation module 154 using the resource constraint parameters 144-1-n. The marker 222 may represent a “You are here” marker that allows an operator to see where the current solution falls within the solution space. The location of the marker 222 is recalculated whenever the user makes changes that affect its location, such as when the operator inputs a new value in the additional resources field 212 thereby causing the resource allocation module 154 to re-execute the allocate resources algorithm to factor in the additional resources 212. When the GUI solution view 148 is first opened or initialized, the marker 222 is typically right on top of the baseline solution indicated by the line 224. It is worthy to note that the marker 222 should be hidden when an operator changes the various chart inputs (e.g., resource constraint, force parameters, schedule, and so forth) until they are recalculated by the resource allocation module 154.

In addition to the marker 222 and the line 224, the solution space chart 220 may further include additional lines (not shown) representing one or more modified sets of solutions generated by the resource allocation module 154 using the resource constraint parameters 144-1-n and the additional resources 212 provided by the portfolio parameters 142-1-m. The solution space chart 220 may also include various GUI elements representing previously saved solutions (not shown). The visual representation of the marker 222 and saved solutions should be chosen so that this initial state can be easily understood by the operator.

FIG. 3 illustrates a GUI view 300. The GUI view 300 may provide an example of a GUI view suitable for use to select various portfolio parameters 142-1-m providing portfolio level controls for the model project investment portfolio 200. It may be appreciated that the GUI view 300 is merely one example of the type of GUI views that may be used to surface options to model changes to the module project investment portfolio 200 for a given planning session.

The GUI view 300 may provide various options to set various portfolio parameters 142-1-m suitable for controlling changes to the model project investment portfolio 200. In the illustrated embodiment shown in FIG. 3, a project scheduling area 302 may allow an operator the option to set a project scheduling dependency parameter. The project scheduling dependency parameter may be used to control any project-to-project dependencies for the individual candidate projects 232, 234 are enforced or not. The project-to-project dependencies are typically defined during initial analysis creation.

An additional resources area 304 may allow an operator to select various options for the portfolio resource constraint parameter 142-1. For example, the additional resources area 304 may include options for a portfolio resource unit parameter, a portfolio resource type parameter, and a portfolio resource rate parameter. The portfolio resource unit parameter may be used to control whether units for the portfolio resource constraint parameter 142-1 are cost units or FTE units, as previously described with reference to FIG. 2. The portfolio resource type parameter may control whether a length of time personnel resources should be hired. For example, when the portfolio resource type parameter is set to internal resources (e.g., employees) for an organization, the resource allocation module 154 may allocate the personnel until the end of a given time constraint (e.g., one year, two years, five years, etc.), or only as needed for a given candidate project 232, 234. The portfolio resource rate parameter may be used to control which cost rate table is used to calculate additional resource costs.

A resource allocation area 306 may allow an operator to select a resource allocation threshold parameter. The resource allocation module 154 may use the resource allocation threshold parameter to determine how many resources to allocate to any given project. In order to resource a maximum amount of projects possible, the resource allocation module 154 utilizes the resource allocation threshold parameter starting with the first candidate project 232, 234 it resources. For example, when the resource allocation threshold parameter is set to 95%, the resource allocation module 154 may allocate up to 95% of the resource required by a candidate project A to the candidate project A. The default value for the resource allocation threshold parameter is typically set to 100%.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

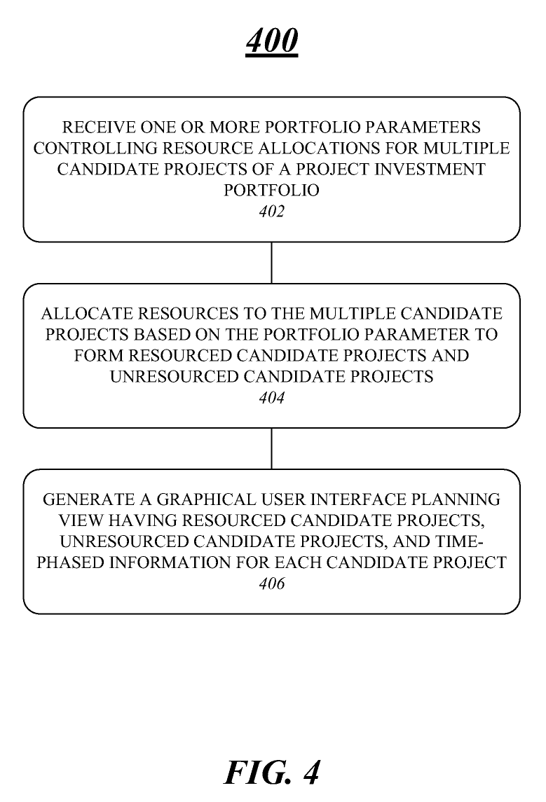

FIG. 4 illustrates one embodiment of a logic flow 400. Logic flow 400 may be representative of some or all of the operations executed by one or more embodiments described herein.

As shown in FIG. 4, the logic flow 400 may receive one or more portfolio parameters controlling resource allocations for multiple candidate projects of a model project investment portfolio at block 402. For example, a portfolio definition module 152 of the PPM component 140 may receive one or more portfolio parameters 142-1-m to control resource allocations for multiple candidate projects 232, 234 of the model project investment portfolio 200. The portfolio definition module 152 may receive them, for example, as operator-selected options from the GUI view 146.

The logic flow 400 may allocate resources to the multiple candidate projects based on the portfolio parameter to form resourced candidate projects and unresourced candidate projects at block 404. For example, the resource allocation module 154 of the PPM component 140 may allocate resources to the multiple candidate projects based on the portfolio parameters 142-1-m to form resourced candidate projects 232 and unresourced candidate project 234. In some cases, the resource allocation module 154 may allocate resources from an initial resource pool to form an initial set of resourced candidate projects 232 and unresourced candidate projects 234 based on the resource constraint parameters 144-1-n defined at a project level, and re-allocate resources from a modified resource pool as expanded to include any additional resources added via the portfolio parameters 142-1-m to form a modified set of resources candidate projects 232 and unresourced candidate projects 234.

The logic flow 400 may generate a GUI planning view having resourced candidate projects, unresourced candidate projects, and time-phased information for each candidate project. For example, the portfolio planning module 156 may generate the GUI planning view 146 to visually illustrate the resourced candidate projects 232, the unresourced candidate projects 234, and the column 250 with time-phased information for each of the projects 232, 234, including a projected start date and a projected end date for each of the projects 232, 234. The number of resource candidate projects 232, the unresourced candidate projects 234, and the various types of time-phased information for the candidate projects 232, 234, may vary in according with the one or more portfolio parameters 142-1-m used to model changes to the model project investment portfolio 200.

FIG. 5 further illustrates a more detailed block diagram of computing architecture 510 suitable for implementing the computing device 110 or the EPM server 130. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more application programs 536-1-t and accompanying data. Depending on the implementation, examples of application programs 536-1-t may include system programs such as an operating system (OS) 536-1 with appropriate GUI interface for supporting the generation of the GUI views 146, 148, 300, an EPM application program 536-2 such as MICROSOFT PROJECT, the PPM component 100, and so forth.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may be representative of, for example, the communications interfaces for the communications components 116-1-v. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

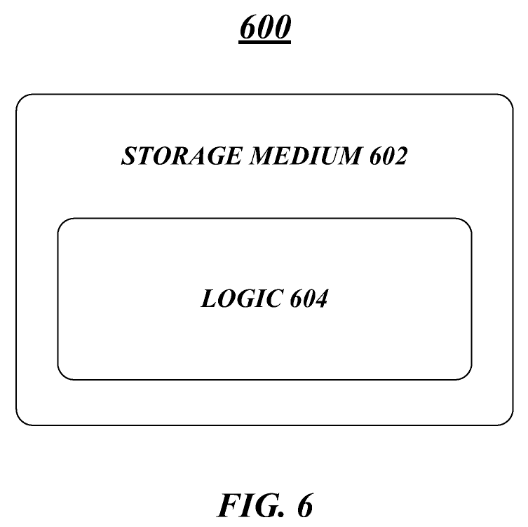

FIG. 6 illustrates a diagram an article of manufacture 600 suitable for storing logic for the various embodiments, including the logic flow 400. As shown, the article 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving one or more portfolio parameters controlling resource allocations for multiple candidate projects of a model project investment portfolio;
allocating resources to the multiple candidate projects based on the portfolio parameter to form resourced candidate projects and unresourced candidate projects; and
generating a graphical user interface planning view having resourced candidate projects, unresourced candidate projects, and time-phased information for each candidate project.

2. The method of claim 1, comprising allocating resources to the multiple candidate projects based on a portfolio resource constraint parameter representing financial resources or full-time equivalents.

3. The method of claim 1, comprising increasing a portfolio resource constraint parameter representing financial resources or full-time equivalents to increase a number of resourced candidate projects.

4. The method of claim 1, comprising selecting a first candidate project to become a resourced candidate project, and a second candidate project to become an unresourced candidate project.

5. The method of claim 1, comprising modifying a start date for a candidate project to increase a number of resourced candidate projects.

6. The method of claim 1, comprising generating a graphic user interface solution view having a solution space chart with an x-axis representing portfolio resource constraint parameters and a y-axis representing strategic portfolio values.

7. The method of claim 1, comprising generating a graphic user interface solution view having a solution space chart with an x-axis representing portfolio resource constraint parameters and a y-axis representing strategic portfolio values, the solution space chart having graphical user interface information representing a change between an original strategic portfolio value for the model project investment portfolio and a modified strategic portfolio value for the model project investment portfolio.

8. The method of claim 1, comprising:
sorting the multiple projects by dependencies, force status and priorities;
determining changes in a resource pool; and
allocating resources to the multiple candidate projects from the resource pool.

9. An article comprising a storage medium containing instructions that if executed enable a system to:
receive one or more portfolio parameters controlling resource allocations for multiple candidate projects of a model project investment portfolio;
allocate resources to the multiple candidate projects based on the portfolio parameter; and
generate a graphical user interface planning view having resourced candidate projects, unresourced candidate projects, and time-phased information for each candidate project.

10. The article of claim 9, further comprising instructions that if executed enable the system to allocate resources to the multiple candidate projects based on a portfolio resource constraint parameter representing financial resources or full-time equivalents.

11. The article of claim 9, further comprising instructions that if executed enable the system to increase a portfolio resource constraint parameter representing financial resources or full-time equivalents to increase a number of resourced candidate projects.

12. The article of claim 9, further comprising instructions that if executed enable the system to select a first candidate project to become a resourced candidate project, and a second candidate project to become an unresourced candidate project.

13. The article of claim 9, further comprising instructions that if executed enable the system to modify a start date for a candidate project to increase a number of resourced candidate projects.

14. The article of claim 9, further comprising instructions that if executed enable the system to generate a graphic user interface solution view having a solution space chart with an x-axis representing portfolio resource constraint parameters and a y-axis representing strategic portfolio values, the solution space chart having graphical user interface information representing a change between an original strategic portfolio value for the model project investment portfolio and a modified strategic portfolio value for the model project investment portfolio.

15. An apparatus, comprising:
a project portfolio management component operative to generate a model project investment portfolio of multiple candidate projects for an organization, the project portfolio management component comprising:
a portfolio definition module operative to receive one or more portfolio parameters controlling resource allocations for multiple candidate projects;
a resource allocation module communicatively coupled to the portfolio definition module, the resource allocation module operative to allocate resources to the multiple candidate projects based on the portfolio parameter to form resourced candidate projects and unresourced candidate projects; and
a portfolio planning module communicatively coupled to the resource allocation module, the portfolio planning module operative to generate a graphical user interface planning view having resourced candidate projects, unresourced candidate projects, and time-phased information for each candidate project.

16. The apparatus of claim 15, the portfolio parameter comprising a portfolio resource constraint parameter, a portfolio resource unit parameter, a portfolio resource type parameter, a portfolio resource rate parameter, a project scheduling dependency parameter, a resource allocation threshold parameter, or a force status parameter.

17. The apparatus of claim 15, the portfolio definition module operative to receive a portfolio parameter comprising a portfolio resource constraint parameter representing financial resources or full-time equivalents, and the resource allocation module operative to allocate resources to the multiple candidate projects based on the portfolio resource constraint parameter.

18. The apparatus of claim 15, comprising a solution space module communicatively coupled to the resource allocation module, the solution space module operative to generate a graphic user interface solution view having a solution space chart with an x-axis representing portfolio resource constraint parameters and a y-axis representing strategic portfolio values.

19. The apparatus of claim 15, the resource allocation module to sort projects by dependencies, force status and priorities, determine changes in a resource pool, and allocate resources to candidate projects from the resource pool.

20. The apparatus of claim 15, comprising an enterprise project management server having the project portfolio management component, the enterprise project management server operative to manage, monitor and assess status of all projects in an organization.
